(19) United States
(12) Patent Application Publication
(10) Pub. No.: US 2017/0076254 A1
(43) Pub. Date: Mar. 16, 2017

(54) SINGLE PLATFORM FOR SENDING REMINDERS

(71) Applicant: PIJONS, INC., Santa Monica, CA (US)

(72) Inventor: KOUROSH GOHAR, SANTA MONICA, CA (US)

(21) Appl. No.: 15/262,414

(22) Filed: Sep. 12, 2016

Related U.S. Application Data
(60) Provisional application No. 62/217,309, filed on Sep. 11, 2015.

(51) Int. Cl. G06Q 10/10; H04W 4/14; H04L 29/08; H04L 12/58

(52) U.S. Cl. CPC G06Q 10/1095; H04L 51/04; H04W 4/14; H04L 67/306

(57) ABSTRACT

The invention comprises a single platform capable of sending reminders between its users and/or the users' respective contacts to not forget an upcoming appointment, meeting, telephone call or virtual call or product pick-ups. This makes keeping track of its users' contact data, upcoming and/or past reminders in a single organized platform. It also provides the user the option to add, send and receive reminders and to add the reminder details in their respective calendars. This platform allows the users of the platform to send reminders via email or SMS and provides its users the option to modify and cancel previously sent reminders. The platform allows the user to send a single or multi-day or repeat reminder to recipients.

### CROSS-REFERENCE TO RELATED APPLICATIONS

This application claims the benefit of U.S. provisional application Ser. No. 62/217,309 filed Sep. 11, 2015, the disclosure of which is hereby incorporated in its entirety by reference herein.

### TECHNICAL FIELD

The present invention comprises a single platform capable of sending reminders between its users and/or the users' respective contacts which include other users, clients, friends, relatives, students, and others.

### BACKGROUND

People do not have a good working method for setting appointments, reminders, notices and messages in a way that not only keeps the information but also automatically reminds the person of all of these appointments, reminders and notices. There is no web site featuring technology for setting appointments, reminders and notices, and creating, sending and receiving messages and notices. People need to be able to have a web site that allows users to easily upload, store and maintain information, important dates and scheduling for many different purposes. This can include personal and business information, task lists, on-line records calendaring and automated reminders.

### SUMMARY

The present invention comprises a single platform capable of sending reminders between its users and/or the users' respective contacts. This makes keeping track of its users' contact data, upcoming and/or past reminders in a single organized platform. This platform provides the users the option to send reminders, add the reminder to their own calendar, check the status of an upcoming reminder and look up a reminder history. This platform helps both its users, and the recipient to not forget an upcoming appointment, meeting, telephonel or virtual call, webinar and/or product pick-ups. This platform allows the users of the platform to send reminders via email and/or SMS (short message service). This platform provides its users the option to modify and/or cancel previously sent reminders. A contact that receives a reminder is a recipient who can accept, deny, confirm, cancel or nor reply to the reminder.

The platform offers its users the option to look up their respective contacts, via a simple search option in the reminder and/or contacts sections of the platform program. In case a user and/or their respective contact's data has not been added to the platform, the user has the option to add the data manually, or automatically, from the users' existing stored contacts from a third party contact list, and/or the users' existing stored contacts from a third party marketing platform.

The platform offers its users the option to look up upcoming reminders sent to other users and/or the users' respective contacts. In addition, the platform offers its users the option to look up past reminders, sent in each of the user's and/or respective contacts history information.

The platform also offers third parties the ability to send reminders on behalf of other users, such as office administrators, personal assistants, event coordinators and/or concierges, as well as other users. The platform can implement a reminder and update function such that a user can send an update to a previously sent reminder to update its attributes such as title, description, time, date, etc.

### DRAWINGS

FIG. 1 is a diagram illustrating the step by step operation of the platform.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

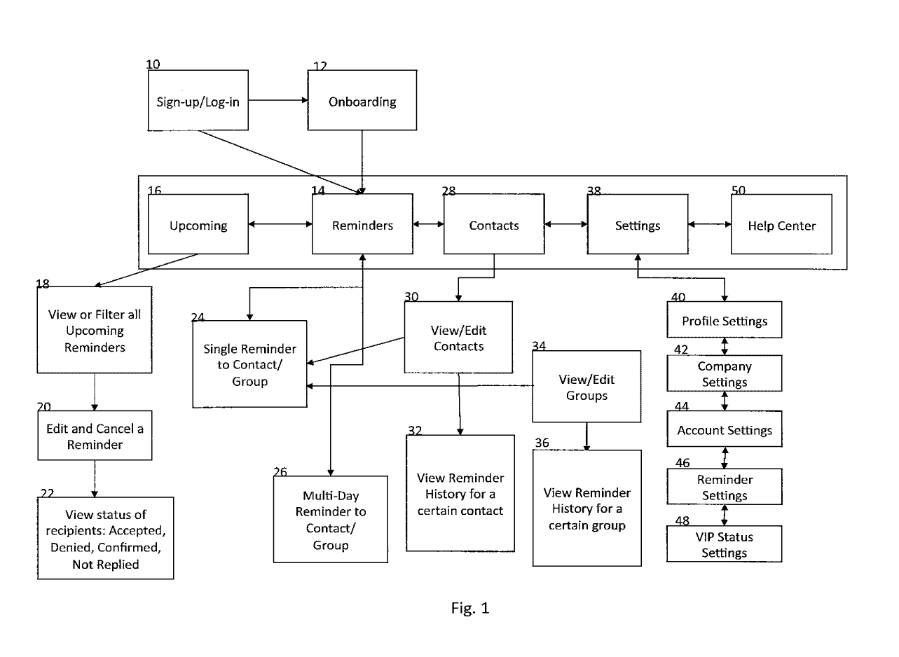

Referring to FIG. 1, there is shown the first step in the utilization of the platform. Step 10 is for a user to Sign-up or Log-in to the system. Step 12 is Onboarding which is the step for user's to sign up into the platform. Users who have signed up can proceed to step 14 to send Reminders. Users can log-in from step 10 to step 14 to send Reminders, without going through step 12. Step 14 Reminders are the central step in which the user can move to step 16, 24, 26, or 28. Step 16, holds Upcoming reminders. In step 18, the user can view or filter all Upcoming reminders. In the view or filter step 18, a reminder can be edited or canceled, Step 20, by the user. A reminder status can be viewed in Step 22 where the user can view the status of recipients' responses, to find out if the reminder has been accepted, denied, confirmed, cancelled or not replied.

In step 24 a user can send a single reminder to a contact or a group. In step 26 a user can send a multi-day reminder to a contact or group. A reminder will move to step 28, Contacts, after its time has expired. A user can view or edit its Contacts info details in step 30. In step 32 a user can view a reminder history for a certain contact. Also, in step 34 a user can view or edit groups info/details. A user can go to step 36 where the user can view a reminder history for a contact or group,

In Settings 38 a user can modify or update profile settings 40, company settings 42, account settings 44, reminder settings, 46 and VIP Status settings 48. There is a Help Center 50 which any user can go to learn more about the site through video or written information.

To send a new reminder, the user needs to select a contact, the recipient of a new reminder, or group, and insert certain required information. The user needs to enter the purpose of the meeting, the date of the meeting, and the time of the meeting. The time selection can be a specific time, a time range (a start and end time), and/or a time range when a service person would show up, or after a specific time. The location of a meeting is optional, it can be a physical location, a phone call, a webinar, a chat or a video presentation.

The recipient will receive the newly sent reminder in an SMS or an email format to view the reminder details. The recipient is provided with a link or a call to action which after selecting will take the recipient to a landing page in order to review the details of the reminder. The recipient has the option of accepting the reminder and adding the reminder details to their own calendar of choice. The landing page shows all details of the newly sent reminder. The recipient has the option to accept or deny the reminder. If the recipient selects to accept or deny the request, the response will be sent to the user who sent the original reminder. A user can send group reminders to a group of people. The same process is used as the single contact, except the recipient information will include multiple contacts.

A user can send reminders using different profiles, such as personal, work or activities. Instead of having multiple accounts for each aspect of the user's life, the user can sign-in from one account to manage their personal profile, work profile and activities profile. A personal profile can be used for friends and family, a work profile for business contacts and an activity profile for a user who is coach, community leader or has a group hobby. As part of the work profile, a user can send reminders for themselves, and/or on behalf of a staff. The staff can be added to the user's profile.

The platform can send auto confirmation requests the day prior to the reminder day to a single contact or a group. Once the recipients confirm or cancel the meeting request, the user is notified of the response. A user can see the status of responses in the Upcoming step 16 or reminder history in step 32.

The platform can allow the user to set a certain number of defaults to simplify further the process of sending new reminders. Search default will list the latest contacts to which new reminders were sent in a chronological order with a limit of contacts shown. As new reminders are sent the search default will replace older ones with the newer contacts in a chronological order.

Profile default will allow the user to set their preferred profile so the platform will automatically select that profile. The default can be over written for a one off if the user selects a different profile. The user can also change their profile default at any time in the Profile setting section of the platform.

Purpose default will allow the user to type in the purpose of a meeting and default it so the platform will automatically list it as the purpose of the meeting. Each profile too, can have its own set of purpose defaults. The default can be over written for a one off if the user elects to type in a different purpose. The user can also change their purpose default at any time.

Location default will allow the user to default a specific location, phone number or a platform name (in case of a virtual call) so the platform will automatically list it as the location of the meeting. If a user enters a contact address for a specific contact in the contacts information section it will also be listed as an option for the user to select when preparing to send a new reminder. The default can be over written for a one off if the user elects to type in a different location. The user can also change their location default for each contact at any time.

Recently group reminder default will list the latest groups to which new reminders were sent. This default is an option for the user to select a group to which it has previously sent a reminder.

Confirmation reminder default will allow the user to send an automatic confirmation request the day prior to the reminder day to the recipient of the reminder. This default can be turned on or off in the Reminder settings section of the platform.

Staff/Service person reminder default will allow the user to send an automatic reminder to the selected Staff/Service person for which the reminder is being sent. This default can be turned on or off in the Reminder settings section of the platform.

Reminders can be sent for a single or multi-day event. A multi-day reminder is similar to sending schedules for conferences, webinars, game schedules, concert schedules and tutoring schedules, etc.

A user can input a title name of the event, a summary description of the event, the date, the time and as many reminders that are grouped together in this (MDR) multi-day reminder. The time selection can be a specific time, a time range (a start and end time), and/or a time range when a service person would show up, or after a specific time. Additional notes of a user's choice are optional. When the MDR has been sent, a recipient receives the same notification as a regular reminder, and the landing page shows all of the events associated with the MDR. The recipient receives the newly sent reminder notice via SMS or email and the details of the reminder will be listed in a landing page, the same as a single reminder. The recipient will determine whether to accept or deny all events or pick and choose to accept or deny between MDR events.

The list of reminder's dates and times in the MDR are chronological. As each event expires, the reminder will shift and relocate its order to the expired section towards the bottom of the reminder list. If there are any changes to the status of the reminder by the sender, such as a cancelled event or an updated event, the status will show up in front of each event listed so the recipient can be aware of all updates in the original MDR invited link. When any of the recipients accept or deny any or all of the newly sent reminders from the MDR, the user will receive updates. The status section of the MDR reminder will be shown in the Upcoming step 16 section of the site. The user can see who has accepted, denied, confirmed, cancelled or not reply the MDR sent. Also, a confirmation reminder per each event of the MDR will be automatically sent to the recipients the day prior to the meeting date.

The user can send repeat reminders to an individual or a group. An initial repeat reminder is sent to the recipient with the details of the repeat reminder. The difference between a single, group or an MDR reminder versus a repeat reminder is that the repeat reminder only sends out the initial reminder once and all future repeat reminders go out the day before the reminder day only as a confirmation request. The user can edit or cancel a repeat reminder. However, the platform will confirm with the user if the edit or the cancellation is for a single reminder or repeat reminders. The user can edit a repeat reminder and has the option to edit and save or edit and send, in which case the recipient will receive the updated edits. Beyond the initial reminder, confirmations are sent out a day prior to all repeat reminders.

The user can see the status of upcoming reminders. The user can look up the status of a previously sent reminder to a single person or a group and see the status of who has accepted, denied, confirmed, cancelled or not reply within a group reminder. The status can be “Sent”, that is when the reminder is sent and waiting for the recipient to accept or deny. “Accepted” is when the recipient has accepted the previously sent reminder. “Confirmed” is when the recipient has confirmed a reminder request the day prior to the reminder day. “Can't make it” is when the recipient has denied the sent reminder. “We Updated” is when the user has edited a previously sent reminder. “We Canceled” is when the user has cancelled a previously sent reminder. “They cancelled” is when the recipient has cancelled the previously sent reminder.

The user can upgrade to a VIP Status in order to send reminders with the user's company branding “White Label”. The user can choose to include their personal initials, their personal profile image, their company logo, or select no image. In addition, the user can select to include their company banner in the header of the email and/or landing pages. The user can include their social media links such as, Facebook, LinkedIn, Pinterest, and/or Twitter. The user can include their company website URL, address, and their company phone number. The VIP Status allows for a user to personalized reminders using their company branding features shown in the email and the landing page a recipient received.

Additional features in the system include the option for the user to receive contact data manually or upload from third party platforms. A user can use the search field to look up existing contacts or previously sent reminders contacts or groups. The user can select which profile to send reminders such as for personal, work or activities. The option to add or select previously added Staff or Service person profiles. The option to add reminders to user's third party calendar.

The platform can add functionality to support user responses, and a two-way conversation between user contacts. Regardless of whether an SMS or email is sent as the original reminder, the user may reply by sending a message to be received by the platform, causing the platform to notify the user of the message. The user can then use the platform to continue the conversation by replying through the user interface. The history of the conversation thread is maintained in the user's records of the user for future review.

The platform can implement functionality for the users to send one-time or recurring marketing campaigns via email, SMS or push notification to their contacts, with information in the message, and with links back to the main site which have more information.

The platform can implement a new tier or variant of the platform to enable a hotel concierge to send reminders to their hotel guests on behalf of companies. As an example, after a concierge has made an appointment with a third party on behalf of a hotel guest, the concierge would send the reminder to the guest and the third party through the platform.

Desktop applications for the platform are applications such as Mac and Windows operating systems which enable platform users to log in, send reminders and manage their contacts and history. This includes automatically updating user's contacts with platforms such as, Apple contacts, Outlook contacts, Google contacts, Yahoo contacts. There are also applications to upgrade or downgrade up to different tier levels.

The platform can implement a new tier or variant of the platform to enable a personal assistant, and/or event coordinator, to send reminders to contacts on behalf of themselves or others to third party companies.

The platform can implement a new tier or variant of the platform which enables a business owner with several employees/staff members to sign up and invite other employees/staff members to use the platform for their company. If the company admin authorizes the staff, they may or may not, have the ability to view reminders, contacts or user history from other employee/staff within their company, depending upon the Company policy. This tier may require a monthly subscription payment.

The platform can add functionality to support user responses, and two-way conversations between users and their contacts. Regardless of whether an SMS or email is sent as the original reminder, the user may reply by sending a message to be received by the platform, causing the platform to notify the user of the message. The user can then use the platform to continue the conversation by replying through the user interface. The history of the conversation thread is maintained in the user's record for future review.

The platform can implement new mobile native applications, such as iOS and Android apps which enable a user to send reminders and manage their contacts and history. This implementation has the option for automatically updating the user's native device calendar after reminders are sent.

The platform can add a feature to the messaging between users and their reminder recipients so that translation between languages is supported. The users may each select their preferred language. If the languages of the user and their reminder recipients are the same, no automatic translation occurs. However, if the languages differ, then the message will be sent in the speaker's language but the recipient will see the message, using machine translation, in the recipient's language. This will use a third party translation service such as Google Translate API.

The platform of this invention comprises computer software used for setting appointments, reminders and notices, and creating, sending, and receiving messages and notices associated thereto and/or update the status of a previously sent reminder. Additional computer software allows users to upload, store, and maintain information, important dates, and scheduling. Other computer software is used for managing contact information, personal and business information, task lists, on-line records, calendaring, and automated reminders. Computer software is also used for data synchronization, electronic mail, push notifications, text messages, and data sharing. Additional software comprises downloadable software for a mobile application used for setting appointments, reminders and notices and creating, sending, and receiving messages and notices associated thereto. Downloadable software for a mobile application allows users to upload, store, and maintain information, important dates, and scheduling as well as a mobile application used for managing contact information, personal and business information, task lists, on-line records, calendaring, and automated reminders. Additional software includes software which allows users to upload, store, and maintain information, important dates, and scheduling in databases.

The system utilizes computer software for setting appointments, reminders and notices and for creating, sending and receiving messages and notices. The software allows users to upload, store, and maintain information, important dates, and scheduling. The software is used for managing contact information, personal and business information task lists, on-line records, calendaring, and automated reminders.

The platform services also include hosting a website used for setting appointments, reminders and notices, and creating, sending and receiving messages and notices associated thereto and hosting a website that allows users to upload, store, and maintain information, important dates, and scheduling; managing contact information, personal and business information, task lists, on-line records, calendaring, automated reminders and mapping services.

With this system the user can send reminders to a single contact or to a group of contacts. The user can also send reminders using different profiles, such as personal profile, work profile, and activities profile. The user can send reminders to staff or service persons. Staff or services persons can also receive the same reminder if needed, similar to being bcc'd. This feature can be disabled in the settings tab, if needed.

The user can send multi-day reminders for multi-day events for a single or multiple locations. The user can send repeat reminders to a single contact or to a group of contacts. The user can see upcoming reminders chronologically or look up upcoming reminders by a selected profile. The user can look up the status of previously sent reminders to a single person or look up the status of a previously sent group reminder. The user can see if the reminder recipient has accepted, denied, confirmed, canceled or not reply to the reminder.

The user can edit upcoming reminders and previously sent reminders to a single contact or a group of contacts. The user can cancel previously sent reminders to a single contact or a group of contacts. The user can upgrade to a VIP Status sending reminders using the user company branding “White Label”.

The system can send data to, or upload from third party platforms to the user account. The system can also edit existing contact information or review the history of previously sent reminders per user contact.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A process for a user scheduling appointments and sending reminders of the appointments to one or more recipients by entering the reminders into a platform database which automatically reminds the recipients of the reminders, in which the platform allows the user to view whether a recipient has accepted, denied, confirmed, canceled or has not replied to the reminder.

2. The process of claim 1 in which the user can edit or cancel a reminder.

3. The process of claim 1 in which the recipient will receive the reminder in an SMS or email format to view the reminder details.

4. The process of claim 3 in which the recipient is provided with a link or a call to action which will take the recipient to a landing page to review the reminder details and the option of adding the reminder details to their own calendar.

5. The process of claim 4 in which the landing page allows the recipient to accept, deny, confirm, cancel or not reply to the reminder and the response is sent to the user who sent the original reminder.

6. The process of claim 1 in which a user can send reminders in different profiles, such as a personal profile, a work profile or an activity profile.

7. The process of claim 1 in which the platform will send a reminder to recipients and can also send an auto confirmation request the day prior to the reminder day to ask the recipient to confirm the reminder.

8. The process of claim 1 in which the platform can enable a hotel concierge, to send calendar reminders to their hotel guests and third party companies.

9. The process of claim 1 in which the platform supports a user sending a message to be received by the platform to allow conversation between users and/or recipients of the user specific reminder.

10. The process of claim 1 in which the platform allows users to upload, store and maintain personal and business information and task lists.

11. The process of claim 1 in which the platform can send data to, or upload from, third party platforms.

12. The process of claim 1 in which the reminder is a multi-day reminder, sent to recipients.

13. The process of claim 1 in which the reminder is a repeat reminder sent to recipients.

14. The process of claim 1 in which an admin or a personal assistant sends the reminders on behalf of themselves or on behalf of others.

15. A process for a user scheduling appointments and sending reminders of the appointments to a contact or a group, the user describing the purpose of the appointment, the date of the appointment, the time of the appointment, and the location of the appointment, entering the reminders into a platform database which automatically reminds the contact or group recipients of the reminders, in which the platform allows the user to view whether recipients have accepted, denied, confirmed, canceled or have not replied to the reminders.

16. The process of claim 15 in which the time selection can be a specific time, a time range or a time range when a service person will show up or after a specific time.

17. The process of claim 15 in which the location can be a physical location, a phone call, a webinar, a chat or a video presentation.

18. The process of claim 15 in which the recipient is provided with a link or a call to action which will take the recipient to a landing page to review the reminder details and the option of adding the reminder details to their own calendar.

19. The process of claim 15 in which a user can send reminders in different profiles, such as a personal profile, a work profile or an activity profile.

20. The process of claim 15 in which the platform allows the user to set defaults to simplify the sending of new reminders by compiling the information of prior searches, profiles, purpose, location, recently group reminder, confirmation reminder, and staff reminder, so that the user does not have to enter the information each time a reminder is sent.
